(19) United States
(12) Patent Application Publication
(10) Pub. No.: US 2025/0018777 A1
(43) Pub. Date: Jan. 16, 2025

(54) Embedded car cover

(71) Applicant: Ningbo Crosstrip Electronic Science Co.,Ltd, Cixi City (CN)

(72) Inventors: Guanqian Gu, Cixi City (CN); Jibo Ruan, Cixi City (CN)

(21) Appl. No.: 18/486,042

(22) Filed: Oct. 12, 2023

(30) Foreign Application Priority Data
Jul. 10, 2023 (CN) 202310841404.2

(51) Int. Cl. B60J 7/14

(52) U.S. Cl. CPC B60J 7/141

(57) ABSTRACT

The present invention discloses a four-fold soft car cover, which includes a transverse support structure and a longitudinal support structure, the transverse support structure includes a side rail and a plurality of joint assemblies, the side rails are connected to each other by the joint assemblies, the joint assemblies include a left connecting part, an intermediate part, and a right connecting part, the left connecting part and right connecting part are respectively connected to the intermediate part by a connecting block, the left connecting section and the right connecting section are both for connecting the side rail. The longitudinal support structure includes a front bar, an intermediate support bar and a locking system bar, the front bar is connected to the side rail by a front bar fixing structure, the intermediate support bar is connected to the joint assembly or to the side rail, the locking system bar is connected to the joint assembly.

### TECHNICAL FIELD

This invention is relevant to automotive spare parts, especially a four-fold soft car cover

### BACKGROUND TECHNOLOGY

The pick-up truck (also known as a sedan truck) is used for carrying goods. Since the pick-up truck's cargo hopper is open, a cover was invented to prevent the goods inside the cargo hopper from getting wet in the rain and snow, by installing the cover on the pick-up truck's cargo hopper and using it to cover the goods inside the hopper.

In order to facilitate the opening of the car cover, it is usually necessary to provide a rotating structure, and since the rotating structure needs to be rotated frequently, the component is vulnerable to damage, and is difficult to repair after damage.

### ABOUT THE INVENTION

The present invention proposes a new car cover to solve the problem that the rotating structure of the existing car cover is vulnerable to damage.

In order to solve the above problems of the existing technology, the technical solution adopted in the invention is as follows:

A four-fold soft car cover includes a transverse support structure and a longitudinal support structure, the transverse support structure and the longitudinal support structure are connected to a waterproof leather.

The transverse support structure includes a side rail and a plurality of joint assemblies, the side rails are connected to each other by a joint assembly, the joint assemblies include a left connecting part, an intermediate part and a right connecting part, the left connecting part and the right connecting part are respectively connected to the intermediate part by a connecting block, the left connecting part and the right connecting part are both for connecting to the side rail.

The longitudinal support structure includes a front bar, an intermediate support bar and a locking system bar, the front bar is connected to the side rail by a front bar fixing structure, the intermediate support bar is connected to the joint assembly or to the side rail, the locking system bar is connected to the joint assembly.

Further, the soft car cover is a four-fold structure, the front bar fixing structure includes a first front bar fixing plate, a second front bar fixing plate, a front bar fixing screw and a front bar fixing nut, the first front bar fixing plate is connected to the second front bar fixing plate by the front bar fixing screw and the front bar fixing nut, the side rail is provided with a side rail groove, the first front bar fixing plate, in sequence from top to bottom, includes a snap-fit section, a first clamping section, a connecting section and a limiting groove, the snap-fit section is provided with a snap-fit convex, the snap-fit convex is connected to the side rail groove, the connecting section is provided with a waist hole, the second front bar fixing plate, in sequence from top to bottom, includes a second clamping section, a mounting section and a limiting plate, the snap-fit section extends into the side rail groove, the first clamping section is provided correspondingly with the second clamping section, the mounting section is connected with an anti-rotation groove, the front bar fixing nut is provided in the anti-rotation groove, the limiting groove is adapted to the limiting plate.

Further, the connecting block includes a first connecting block hole and a second connecting block hole, the left connecting part is connected to the intermediate part through the connecting block, the first connecting block hole is connected to the intermediate part, the second connecting block hole is connected to the left connecting part, the right connecting part is connected to the intermediate part by the connecting block, the first connecting block hole is connected to the right connecting part, the second connecting block hole is connected to the intermediate part, as both the left connecting part and the right connecting part are to be rotationally connected with the intermediate part, in order to prevent the leather from being damaged in the process of rotation, two rotation centres are set asymmetrically, that is to say, one rotation centre is set at the intermediate part and the other is set at the left connecting part or the right connecting part, so that the leather will not be piled up or stretched during the rotation process, the left connecting part is provided with a positioning block, the connecting block is provided with a positioning groove, the positioning groove is set correspondingly with the positioning block, by setting the positioning block and the positioning groove, the positioning groove is snap-fit with the locating block during installation, so that the connecting block is installed to a predetermined position to ensure installation accuracy, the intermediate part is provided with a positioning block, the connecting block is provided with a positioning groove, this invention sets the other rotation centre at the right connecting part, so that a positioning block has to be provided on the intermediate part to locate it, while in practice, the rotation centre can also be set at the left connecting part.

Further, the joint assembly also includes a screw, the left connecting part is provided with a left connecting part self-locking hole, the connecting block is provided with a second connecting block hole, the screw passes through the second connecting block hole to connect with the left connecting part self-locking hole and connects the connecting block to the left connecting part, the left connecting part is provided with a self-locking nut, by using the screw is to connect the left connecting part and the connecting block, the connecting block can drive the left connecting part to rotate together when it rotates, due to the frequent rotation of the left connecting part and the intermediate part, they are prone to be damaged at the point of rotation, therefore, the connecting block is made into a split structure with the left connecting part, which on the one hand facilitates the replacement of the damaged connecting block, on the other hand, it greatly prolongs the service life of the connecting block by adopting a metal material, the joint assembly further includes a screw, the screw passes through the mounting hole, the first connecting block hole and the self-locking hole and is connected to the self-locking nut, the screw is the rotation centre of the left connecting part and the intermediate part, the left connecting part and the intermediate part rotate around the screw.

Further, the left connecting part further comprises a first left plug, a second left plug and a third left plug, the right connecting part includes a first right plug and a second right plug, the first left plug, second left plug, first right plug and second right plug are all connected to the side rails, the third left plug is connected to the intermediate support bar.

Further, the integrated rear bar includes a rear bar joint, a tail bar and a rear locking system lever, the rear bar joint includes a first joint plug, a second joint plug, a third joint plug, a fourth joint plug, a fifth joint plug and a sixth joint plug, the tail bar includes a first tail bar through-hole, a second tail bar through-hole and a third tail bar through-hole, the fifth joint plug is connected to the first tail bar through-hole, the fourth joint plug is connected to the second tail bar through-hole, the sixth joint plug is connected to the third tail bar through-hole, the rear locking system lever is provided with a rear bar locking bolt through-hole, the first joint plug is connected to a rear bar locking bolt through-hole, the second joint plug is connected to a side rail groove, the third joint plug is connected to a side rail through-hole, using the rear bar joint to connect the rear locking system lever with the tail bar to form an integrated structure, by the design of a plurality of joint plugs, the rear rail joint connects the tail bar, the rear locking system lever and the side rails at the same time with a stable structure.

Further, the joint assembly includes a large joint assembly, a medium joint assembly and a small joint assembly, the large joint assembly, the medium joint assembly and the small joint assembly can be arranged arbitrarily, as long as the plurality of side rails are connected.

The beneficial effects of the invention are as follows.
1. The present invention, by changing the structure of the joint assembly and designing the connecting block as a split structure, which not only enables the material of the connecting block to be replaced so as to provide better stress performance and prolong the service life, but also facilitates the disassembly and maintenance of the connecting block.
2. The present invention by changing the front bar fixing structure, using the clamping force to connect the front bar with the guide rail, not only convenient to connect, but also good stability.
3. The invention by changing the tail bar joint, the rear locking system lever and the tail bar is connected as a integrated structure through the rear bar joint, which is convenient for the overall installation.

### DESCRIPTION OF DRAWINGS

FIG. 1 is a structure schematic diagram I of the present invention I.

FIG. 2 is a structure schematic diagram II of the present invention.

FIG. 3 is a structure schematic diagram III of the present invention.

FIG. 4 is a partially enlarged view of part A in FIG. 3.

FIG. 5 is a structure schematic diagram of the front bar fixing structure in FIG. 4.

FIG. 6 is a structure schematic diagram IV of the present invention.

FIG. 7 is a partially enlarged view of part B in FIG. 6.

FIG. 8 is a structure schematic diagram of the joint assembly in FIG. 1.

FIG. 9 is a structure schematic diagram II of the joint assembly in FIG. 1.

FIG. 10 is a partially enlarged view of part C in FIG. 9.

FIG. 11 is a structure schematic diagram III of the joint assembly in FIG. 1;

FIG. 12 is a structure schematic diagram IV of the joint assembly in FIG. 1.

Figures: Figure in: 1—Large joint assembly, 101—Left connecting part, 1011—First left plug, 1012—Second left plug, 1013—Third left plug, 1015—Left connecting part self-locking hole 1016—Positioning block, 102—Intermediate part, 1021—Self-locking hole, 1022—Mounting hole, 1023—Intermediate self-locking hole, 103—Right connecting part, 1031—First right plug, 1032—Second right plug, 104—Connecting block, 1041—First connecting block hole, 1042—Second connecting block hole, 1043—Positioning groove, 105—Screw, 106—Bolt, 2—Medium joint assembly, 3—Small joint assembly, 4—Front bar fixing structure, 401—First front bar fixing plate, 4011—Clamping protrusion, 4012—First clamping section, 4013—Waist hole, 4014—Limiting groove, 402—Second front bar fixing plate, 4021—Second clamping section, 4022—Anti-rotation groove, 4023—Limiting plate, 403—Front bar fixing screws, 404—Front bar fixing nut, 5—Side rail, 501—Side rail groove, 502—Side rail through-hole, 6—Front bar, 7—Intermediate support bar, 8—Locking system bar, 9—Integrated rear bar, 901—Rear bar joint, 9011—First joint plug, 9012—Second joint plug, 9013—Third joint plug, 9014—Fourth joint plug, 9015—Fifth joint plug, 9016—Sixth joint plug, 902—tail bar, 9021—First tail bar through-hole, 9022—Second tail bar through-hole, 9023—Third tail bar through-hole, 903—Rear locking system lever, 9031—Rear locking bolt lever through hole.

### THE CONCRETE METHOD TO CARRY OUT

The following instruction further explains the invention's concrete implementation method.

In order to enable a clearer understanding of the objects mentioned above, features and advantages of the present invention, the invention is described in detail below in connecting with the accompanying drawings and specific embodiments. It should be noted that the embodiments of the present invention and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two assemblies. For those of ordinary skill in this field, specific meanings of the above terms in the present invention can be understood in specific situations.

The specific embodiments of the present invention will be described in detail below in connecting with the accompanying drawings. It should be understood that the specific embodiments described herein are intended only to illustrate and explain the present invention and not to limit it.

### Embodiment 1

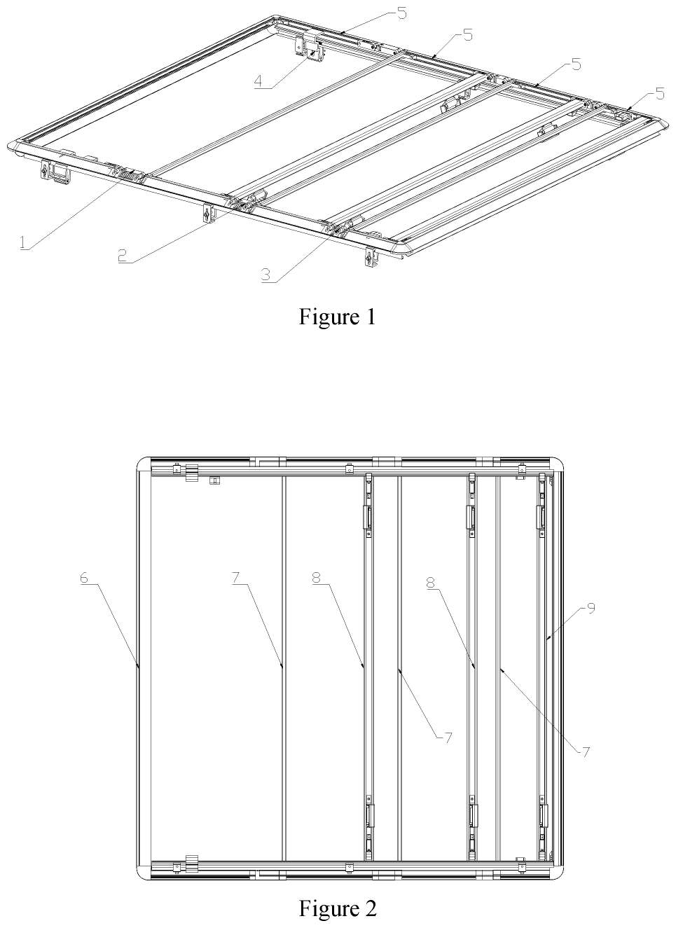

As shown in FIGS. 1, 2 and 8, a four-fold soft car cover includes a transverse support structure and a longitudinal support structure.

The transverse support structure includes a side rail 5 and a plurality of joint assemblies, the side rails 5 are connected to each other by a joint assembly (the joint assembly is a centre of rotation, the number of joint assemblies represents the times the car cover can be folded), the joint assemblies include a left connecting part 101, an intermediate part 102 and a right connecting part 103, the left connecting part 101 and the right connecting part 103 are respectively connected to the intermediate part by a connecting block 104, both the left connecting part 101 and the right connecting part 103 are for connecting the side rail 5.

The longitudinal support structure includes a front bar 6, an intermediate support bar 7 and a locking system bar 8, the front bar 6 is connected to the side rails 5 or to the guide rails by a front bar fixing structure 4, the intermediate support bar 7 is connected to the joint assembly or to the side rail 5, the locking system bar 8 is connected to the joint assembly or to the side rail 5.

### Embodiment 2

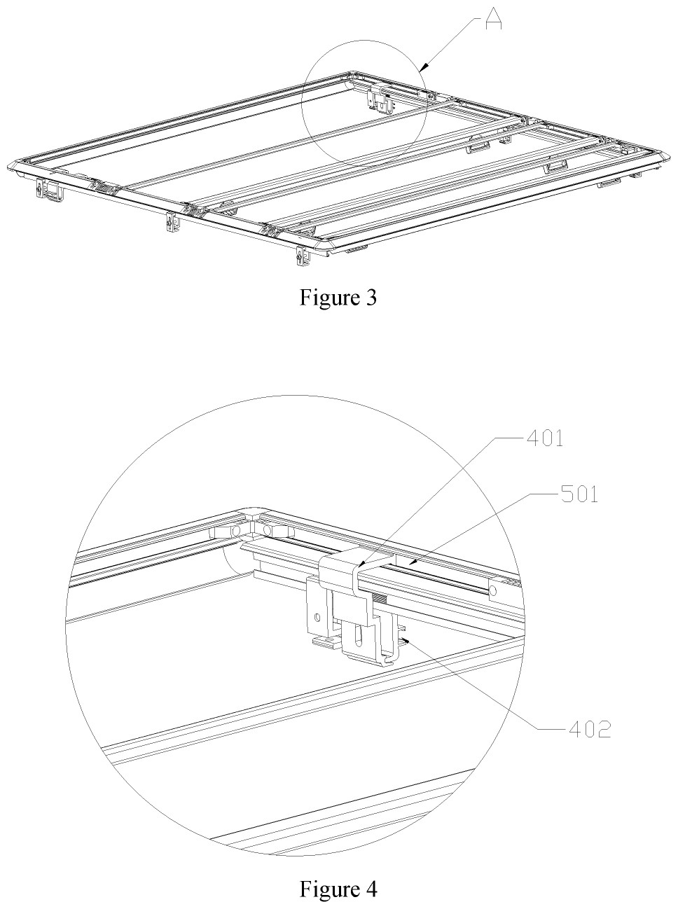

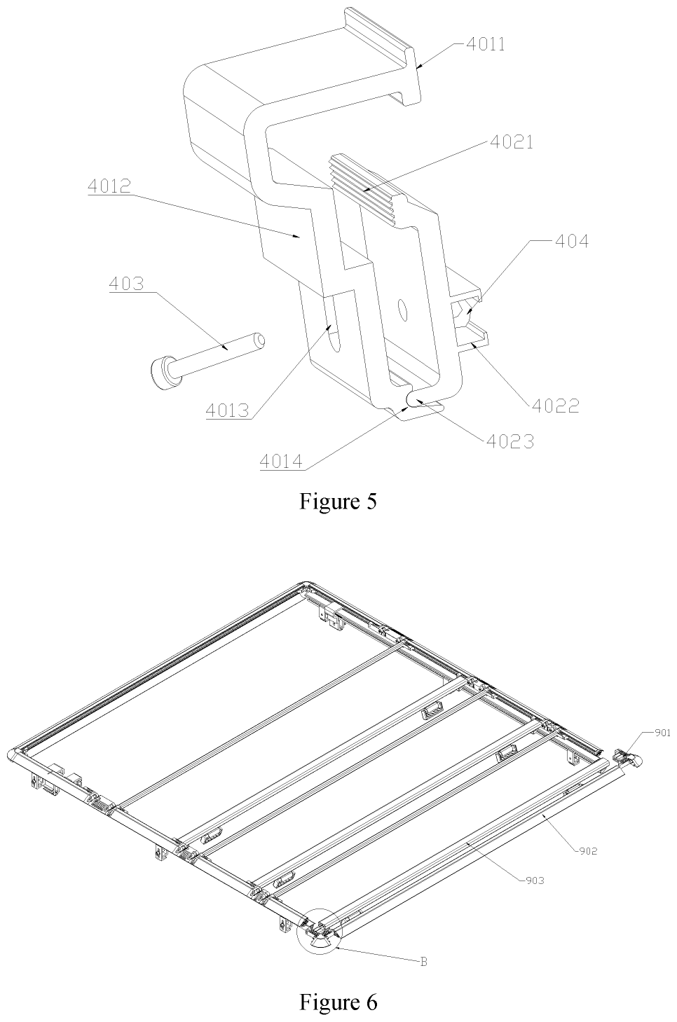

On the basis of embodiment 1, as shown in FIGS. 3-5, the soft car cover is a four-fold structure, the front bar fixing structure 4 includes a first front bar fixing plate 401, a second front bar fixing plate 402, a front bar fixing screw 403 and a front bar fixing nut 404, the first front bar fixing plate 401 is connected to the second front bar fixing plate 402 by the front bar fixing screw 403 and the front bar fixing nut 404.

The side rail 5 is provided with a side rail groove 501, the first front bar fixing plate 401, in sequence from top to bottom, includes a snap-fit section, a first clamping section 4012, a connecting section and a limiting groove 4014, the snap-fit section is provided with a snap-fit convex 4011, the snap-fit convex 4011 is connected to the side rail groove 501, the connecting section is provided with a waist hole 4013.

The second front bar fixing plate 402, in sequence from top to bottom, includes a second clamping section 4021, a mounting section and a limiting plate 4023.

The snap-fit section extends into the side rail groove 501, the first clamping section 4012 is provided in correspondence with the second clamping section 4021, the mounting section is connected with an anti-rotation groove 4022, the front bar fixing nut 404 is provided in the anti-rotation groove 4022, the limiting groove 4014 is adapted to the limiting plate 4023.

When installed, the first front bar fixing plate 401 and the second front bar fixing plate 402 are respectively provided on both sides of the guide rail to make the limiting plate 4023 and the limiting groove 4014 snap together correspondingly, then make the front bar fixing screws 403 pass through the waist holes 4013 to connect with the front bar fixing nuts 404 in the anti-rotation groove 4022, and clamp the guide rail by using the first clamping portion 4012 and the second clamping portion 4021 to realise the connection between the front bar 6 and the guide rail.

### Embodiment 3

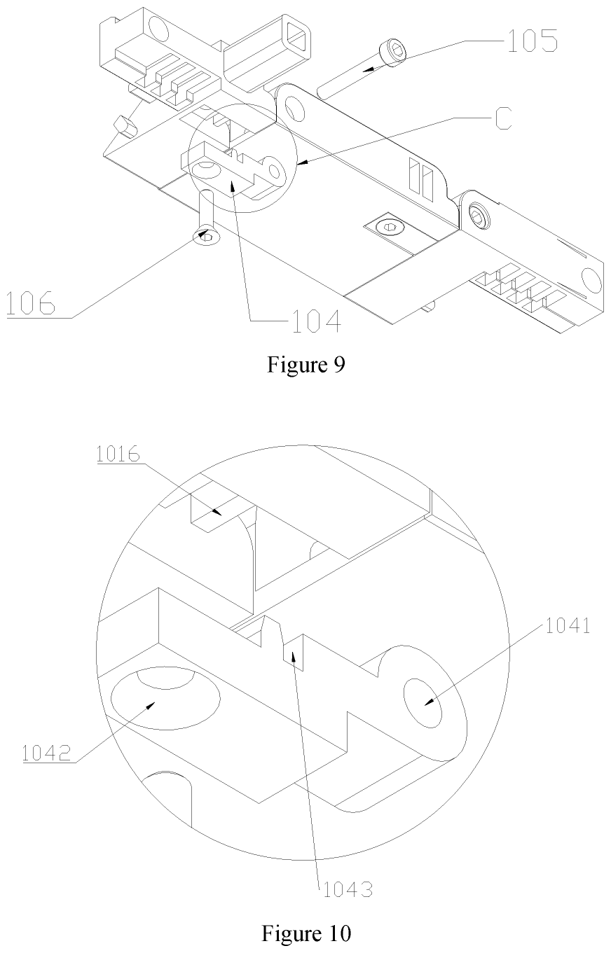

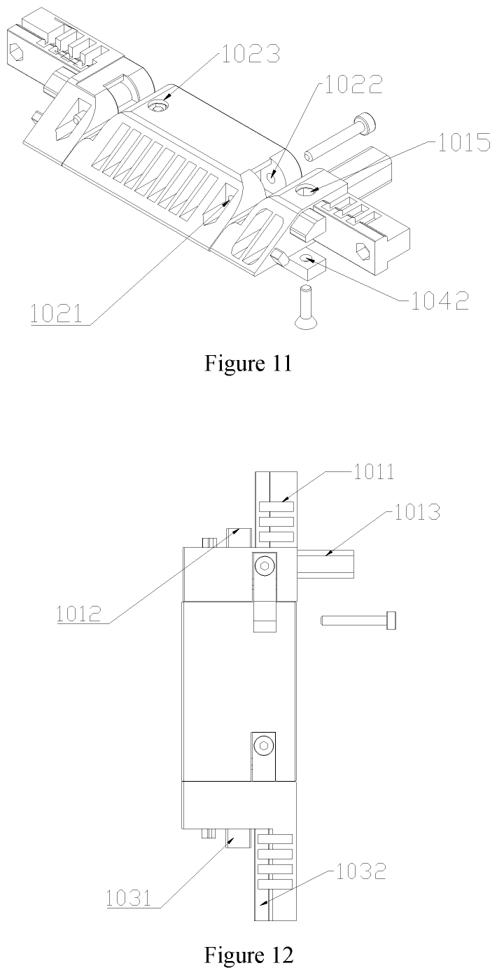

On the basis of embodiment 2, as shown in FIGS. 9-12, the connecting block 104 includes a first connecting block hole 1041 and a second connecting block hole 1042.

The left connecting part 101 is connected to the intermediate part 102 through the connecting block 104, the first connecting block hole 1041 is connected to the intermediate part 102, the second connecting block hole 1042 is connected to the left connecting part 101.

The right connecting part 103 is connected to the intermediate part 102 by a connecting block 104, the first connecting block hole 1041 is connected to the right connecting part 103, the second connecting block hole 1042 is connected to the intermediate part 102.

As both the left connecting part 101 and the right connecting part 103 are to be rotationally connected with the intermediate part 102, in order to prevent the leather from being damaged in the process of rotation, two rotation centres are set asymmetrically, that is to say, one rotation centre is set at the intermediate part 102 and the other rotation centre is set at the left connecting part 101 or the right connecting part 103, so that the leather will not be piled up or stretched during the rotation process.

The left connecting part 101 is provided with a positioning block 1016, the connecting block 104 is provided with a positioning groove 1043, the positioning groove 1043 is provided in correspondence with the positioning block 1016.

By setting the locating block 1016 and the locating groove 1043, the locating groove 1043 is snap-fit with the locating block 1016 during installation, so that the connecting block 104 is installed to a predetermined position to ensure installation accuracy.

The intermediate part 102 is provided with a positioning block 1016, the connecting block 104 is provided with a positioning groove 1043, the positioning groove 1043 is provided in correspondence with the positioning block 1016.

The present application sets the other rotation centre at the right connecting part 103, so that a positioning block 1016 has to be provided on the intermediate part 102 to locate it, while in practice, the rotation centre can also be set at the left connecting part 101.

The joint assembly further includes a screw 106, the left connecting part 101 is provided with a left connecting part self-locking hole 1015, the connecting block 104 is provided with a second connecting block hole 1042, the screw 106 passes through the second connecting block hole 1042 to connect with the left connecting part self-locking hole 1015 and connects the connecting block 104 to the left connecting part 101, the left connecting part self-locking hole 1015 is provided with a self-locking nut.

The screw 106 is used to connect the left connecting part 101 and the connecting block 104, the connecting block 104 can drive the left connecting part 101 to rotate together when it rotates, due to frequent rotation of the left connecting part 101 and the intermediate part 102, it is prone to be damaged at the point of rotation, therefore the connecting block 104 is made into a split structure with the left connecting part 101, which on the one hand facilitates the replacement of damaged connecting block 104, and on the other hand, it greatly prolongs the service life of the connecting block 104 by adopting the metal material.

The joint assembly further includes a screw 105, the screw 105 passes through the mounting hole 1022, the first connecting block hole 1041 and the self-locking hole 1021 and is connected to a self-locking nut.

The screw 105 is the rotation centre of the left connecting part 101 and the intermediate part 102, the left connecting part 101 and the intermediate part 102 rotate around the screw 105.

Similarly, the other connecting block 104 is provided with a second connecting block hole 1042 to connected an intermediate self-locking hole 1023, the intermediate self-locking hole 1023 is provided in the intermediate part 102, the first connecting block hole 1041 is connected to the right connecting part 103 as the rotation centre of the intermediate part 102 and the right connecting part 103.

### Embodiment 4

On the basis of embodiment 3, the left connecting part 101 further includes a first left plug 1011, a second left plug 1012 and a third left plug 1013, the right connecting part 103 includes a first right plug 1031 and a second right plug 1032, the first left plug 1011, second left plug 1012, first right plug 1031 and second right plug 1032 are all connected to the side rail 5, the third left plug 1013 is connected to the intermediate support bar 7.

### Embodiment 5

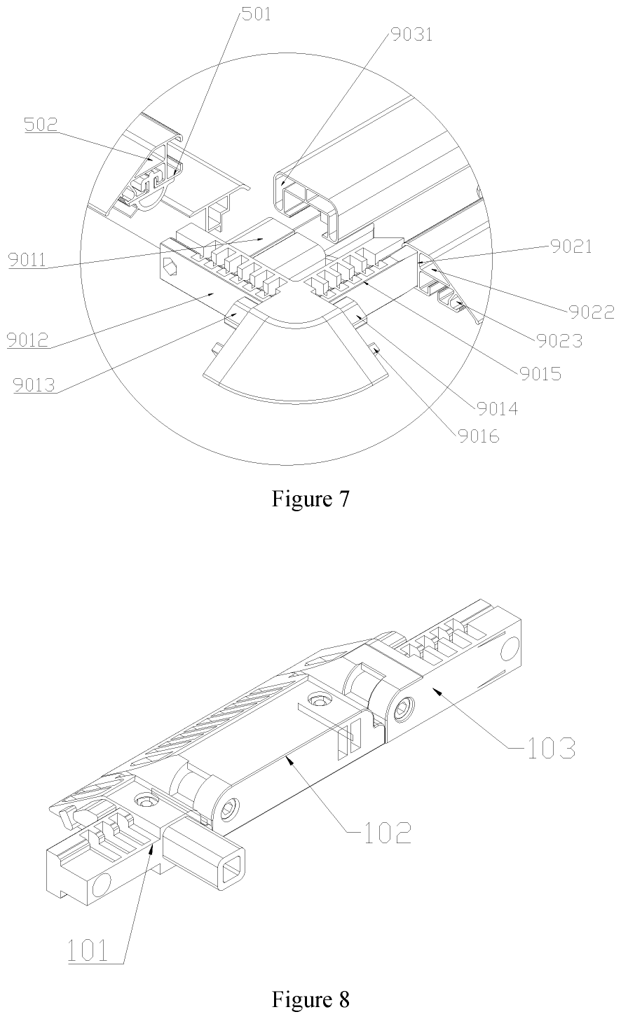

Based on embodiment 4, as shown in FIGS. 6 and 7, the integrated rear bar 9 includes a rear bar joint 901, a tail bar 902 and a rear locking system lever 903.

That rear bar joint 901 includes a first joint plug 9011, a second joint plug 9012, a third joint plug 9013, a fourth joint plug 9014, a fifth joint plug 9015, and a sixth joint plug 9016.

The tail bar 902 includes a first tail bar through-hole 9021, a second tail bar through-hole 9022 and a third tail bar through-hole 9023, the fifth joint plug 9015 is connected to the first tail bar through-hole 9021, the fourth joint plug 9014 is connected to the second tail bar through-hole 9022, the sixth joint plug 9016 is connected to the third tail bar through-hole 9023.

The rear locking system lever 903 is provided with a rear locking bolt lever through-hole 9031, the first joint plug 9011 is connected to a rear locking bolt lever through-hole 9031;

The second joint plug 9012 is connected to a side rail groove 501, the third joint plug 9013 is connected to a side rail through-hole 502.

The rear bar joint 901 is used to connect the rear locking system lever 903 to the tail bar 902 to form an integrated structure.

By the design of a plurality of joint plugs, the rear bar joint 901 connects the tail bar 902, the rear locking system lever 903 and the side rails 5 together at the same time with a stable structure.

The joint assembly includes a large joint assembly 1, a medium joint assembly 2 and a small joint assembly 3, the large joint assembly 1, the medium joint assembly 2 and the small joint assembly 3 can be arranged arbitrarily, as long as the plurality of side rails 5 are connected.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

1. A soft car cover, wherein, it includes a transverse support structure and a longitudinal support structure;
The transverse support structure includes a side rail (5) and a plurality of joint assemblies, the side rails (5) are connected to each other by a joint assembly, the joint assemblies include a left connecting part (101), an intermediate part (102), and a right connecting part (103), the left connecting part (101) and right connecting part (103) are respectively connected to the intermediate part (102) by a connecting block (104), the left connecting part (101) and the right connecting part (102) are both for connecting the side rail.
The longitudinal support structure includes a front bar (6), an intermediate support bar (7) and a locking system bar (8), the front bar (6) is connected to the guide rail by a front bar fixing structure (4), the intermediate support bar (7) is connected to the joint assembly or to the side rail (5), the locking system bar (8) is connected to the joint assembly.

2. A soft car cover according to claim 1, wherein, the soft car cover is a four-fold structure, the front bar fixing structure (4) includes a first front bar fixing plate (401), a second front bar fixing plate (402), a front bar fixing screw (403) and a front bar fixing nut (404), the first front bar fixing plate (401) is connected to the second front bar fixing plate (402) by the front bar fixing screws (403) and front bar fixing nuts (404).
The side rail (5) is provided with a side rail groove (501), the first front bar fixing plate (401), in sequence from top to bottom, includes a snap-fit section, a first clamping section (4012), a connecting section and a limiting groove (4014), the snap-fit section is provided with a snap-fit convex (4011), the snap-fit convex (4011) is connected to the side rail groove (501), the connecting section is provided with a waist hole (4013).
The second front bar fixing plate (402), in sequence from top to bottom, includes a second clamping section (4021), a mounting section and a limiting plate (4023).
The snap-fit section extends into the side rail groove (501), the first clamping section (4012) is provided in correspondence with the second clamping section (4021), the mounting section is connected with an anti-rotation groove (4022), the front bar fixing nut (404) is provided in the anti-rotation groove (4022), the limiting groove (4014) is adapted to the limiting plate (4023).

3. A soft car cover according to claim 1, wherein, the connecting block (104) includes a first connecting block hole (1041) and a second connecting block hole (1042).
The left connecting part (101) is connected to the intermediate part (102) by the connecting block (104), the first connecting block hole (1041) is connected to the intermediate part (102), the second connecting block hole (1042) is connected to the left connecting part (101).
The right connecting part (103) is connected to the intermediate part (102) by the connecting block (104), the first connecting block hole (1041) is connected to the right connecting part (103), the second connecting block hole (1042) is connected to the intermediate part (102).

4. A soft car cover according to claim 3, wherein, the left connecting part (101) is provided with a positioning block (1016), the connecting block (104) is provided with a positioning groove (1043), the positioning groove (1043) is provided in correspondence with the positioning block (1016).

5. A soft car cover according to claim 4, wherein, the intermediate part (102) is provided with a positioning block (1016), the connecting block (104) is provided with a positioning groove (1043), the positioning groove (1043) is provided in correspondence with the positioning block (1016).

6. A soft car cover according to claim 1, wherein, the joint assembly further includes a screw (106), the left connecting part (101) is provided with a left connecting part self-locking hole (1015), the connecting block (104) is provided with a second connecting block hole (1042), the screw (106) passes through the second connecting block hole (1042) to connect the left connecting part self-locking hole (1015) and connects the connecting block (104) to the left connecting part self-locking hole (1015), the left connecting part self-locking hole (1015) is provided with a self-locking nut.

7. A soft car cover according to claim 6, wherein, the joint assembly further includes a screw (105), the screw (105) passes through a mounting hole (1022), a first connecting block hole (1041) and a self-locking hole (1021), and is connected with a self-locking nut.

8. A soft car cover according to claim 5, wherein, the left connecting part (101) further includes a first left plug (1011), a second left plug (1012) and a third left plug (1013), the right connecting part (103) includes a first right plug (1031) and a second right plug (1032), the first left plug (1011), second left plug (1012), first right plug (1031) and second right plug (1032) are all connected to the side rail (5), the third left plug (1013) is connected to the intermediate support bar (7).

9. A soft car cover according to claim 1, the integrated rear bar (9) includes a rear bar joint (901), a tail bar (902) and a rear locking system lever bar (903).
The rear bar joint (901) includes a first joint plug (9011), a second joint plug (9012), a third joint plug (9013), a fourth joint plug (9014), a fifth joint plug (9015), and a sixth joint plug (9016).
The tail bar (902) includes a first tail bar through-hole (9021), a second tail bar through-hole (9022) and a third tail bar through-hole (9023), the fifth joint plug (9015) is connected to the first tail bar through-hole (9021), the fourth joint plug (9014) is connected to the second tail bar through-hole (9022), the sixth joint plug (9016) is connected to the third tail bar through-hole (9023).
The rear locking system lever (903) is provided with a rear locking bolt lever through-hole (9031), the first joint plug (9011) is connected to the rear locking bolt lever through-hole (9031).
The second joint plug (9012) is connected to the side rail groove (501), the third joint plug (9013) is connected to the side rail through hole (502).

10. A soft car cover according to claim 1, wherein, the joint assembly includes a large joint assembly (1), a medium joint assembly (2) and a small joint assembly (3), with the large joint assembly (1), the medium joint assembly (2) and the small joint assembly (3) are arranged in an arbitrary row.
